(19) United States
(12) Patent Application Publication
(10) Pub. No.: US 2018/0223128 A1
(43) Pub. Date: Aug. 9, 2018

(54) OIL-, WAX- OR FAT-BASED ANTI-CORROSION COMPOSITION FOR A METAL STRUCTURE, ESPECIALLY FOR PRE-STRESSING STEEL

(71) Applicant: WERTEC GMBH, Wien (AT)

(72) Inventor: Martin Frühauf, Wien (AT)

(21) Appl. No.: 15/767,297

(22) PCT Filed: Oct. 12, 2016
(86) PCT No.: PCT/EP2016/074411

§ 371 Date: Apr. 10, 2018

(30) Foreign Application Priority Data
Oct. 13, 2015 (EP) 15189545.5

(51) Int. Cl. C09D 191/00; E04C 5/08; C09D 5/08; C09D 5/33; C09D 5/04; C09D 5/00; C09D 7/63; C09D 7/43; C09D 7/48; C09D 5/22; C09K 11/06; G01N 17/00; G01N 21/88; G01N 21/27

(52) U.S. Cl. CPC C09D 191/00; C09K 2211/1018; C09D 5/086; C09D 5/004; C09D 5/04; C09D 5/00; C09D 7/63; C09D 7/43; C09D 7/48; C09D 5/22; C09K 11/06; G01N 17/006; G01N 21/8806; G01N 21/272; E04C 5/08

(57) ABSTRACT

The present invention provides an anti-corrosion composition for a metal surface, especially of pre-stressing steel, the anti-corrosion composition being thixotropic and comprising an organic component which is an oil, fat or wax. The anti-corrosion composition of the invention is characterized in that it is translucent and also comprises an indicator which responds to corrosion of the metal surface by changing its absorption spectrum in the region of ultra-violet, visible or infra-red light, in particular with a colour change. Further provided in accordance with the invention are a metal structure bearing the anti-corrosion composition of the invention, an apparatus on the metal structure, and a method for checking the metal structure.

The present invention relates to oil-, wax- or fat-based thixotropic corrosion protection agents for metal surfaces, in particular of prestressing steel.

Prestressing systems in the form of steel reinforcements or tendons are usually employed in concrete constructions. In these systems, the stressed tendons support themselves on the concrete via their anchors or by means of direct bonding to the concrete, thus applying a pressure load to the concrete. This method compensates for the lack of tensile strength of the concrete and thus generates compression strengths with a significantly improved load-bearing capacity. This system is employed for ground anchors, ceiling constructions, tower constructions, bridge building and a plurality of other applications.

To this end, for example, tensioning devices consisting of rods, individual wires or strands are used, which are usually made of high-strength steel. Among the different types of prestressing steel, 7-wire prestressing steel strands are most commonly employed. At present, three types of strands are generally available on the market: non-coated strands, strands having a metallic or a non-metallic coating as a factory-provided corrosion protection, and strands which are sheathed with a synthetic material, wherein the hollow space between the sheath and the strand is filled with a corrosion protection material. The latter are referred to as monostrands in the prior art.

Prestressing steel (e. g. monostrands), as it is used, for example, in prestressed concrete (also referred to as reinforcement), is highly susceptible to corrosion, in particular owing to the high tensile stress. In the prior art, corrosion protection materials for prestressing steel are known, for which diverse fats and waxes obtained from petroleum refining are commonly used.

Document DE 3 806 350 A1 discloses an anti-corrosion coating material for steel, in particular for reinforcing steel used in concrete, which contains linseed oil, wood oil or bodied oil, calcium stearate, aluminum silicate, red lead, blown bitumen, n-butanol, cobalt naphthenate and a solvent as mixture components in defined proportions.

Document DE 3 644 414 A1 refers to a synthetic material for filling the hollow spaces present inside a synthetic material tube which is filled with a plurality of parallel steel wires or steel strands, as it is, for example, used as a tensioning member for cable-stayed bridges or the like, said synthetic material consisting of an initially fluid synthetic material, such as polyurethane, which then passes over into a solid, easily deformable state upon the addition of curing agent, wherein the synthetic material is mixed with powdery, solid, basic particles, e. g. obtained from cement, fly ash or the like, and with closed-pore, easily deformable, compressible particles, e. g. obtained from milled foam material, cork or the like, in the liquid phase. The synthetic material according to document DE 3 644 414 A1 is a corrosion protection agent, as can be taken, for example, from the second paragraph.

Document EP 0 105 839 A2 discloses tensioning elements having a two-layer plastic sheath, wherein the inner layer is deformable, storage-stable at room temperature and thermally curable, and the outer layer is made of a radiation-cured synthetic material. Such tensioning elements are suitable for the production of load-bearing construction elements, in particular for concrete support structures and rock anchors. After processing, e. g. to form concrete support structures, the plastic sheath is supposed to provide an effective means of corrosion protection.

Within the scope of the present invention it was found advantageous if the prestressing steel present in the prestressed concrete can be removed from the prestressed concrete for inspection purposes (in particular testing for corrosion) without being damaged or destroyed and, if necessary, be replaced.

Document DE 4 106 309 A1 thus relates to a method for replacing or inspecting prestressed reinforcement elements arranged inside a sheathing tube and subsequently bonded to prestressed concrete elements. Here, a soluble thermoplastic material or a soluble thermosetting material serves as a composite material, which at any given point in time—by means of either an increase in temperature or a solution process using a solvent or by the use of microorganisms capable of digesting synthetic material—changes its composite properties in such a way that the reinforcement, which has previously been bonded to the concrete body in a shear-resistant manner, can easily be removed or inspected, if necessary. According to the given Example, the composite material is supposed to protect the tendons from corrosion or other damage.

Furthermore, document EP 0 771 593 A2 relates to a method and a device for laying bare and cleaning limited-length portions of strands made of steel wires which are covered in a corrosion protection material, in particular fat, and are sheathed in a synthetic sheathing together with the corrosion protection material.

The prior art methods for conducting a corrosion inspection of prestressing steel furnished with a corrosion protection material are highly complex because they usually require removing the corrosion protection material from the prestressing steel or even pulling the prestressing steel out of the concrete construction. In general, however, it is mandatory to test prestressing steel for corrosion at regular intervals.

It is thus an object of the present invention to facilitate the conduct of a corrosion test on prestressing steel that is furnished with a corrosion protection material.

The present invention provides a corrosion protection agent (n the following also referred to as corrosion protection material) for a metal surface, wherein the corrosion protection agent comprises an organic component, which is present in the form of an oil, a fat or a wax, and is thixotropic. The corrosion protection agent is particularly suitable for prestressing steel. The corrosion protection agent according to the present invention is characterized in that it is light-transmissive is and further comprises an indicator. The indicator is sensitive to the presence of corrosion on the metal surface and reacts by modifying its absorption spectrum within the range of ultraviolet, visible or infrared light; preferably, the indicator reacts to the presence of corrosion on the metal surface by changing its color. In particular, the corrosion protection agent comprises as an indicator a color indicator for metal cations, in particular for iron cations. In further aspects, the present invention provides a method for furnishing a metal structure, which is surrounded by a sheath, with a corrosion protection agent; a metal structure furnished with the corrosion protection agent according to the present invention; a device arranged on a metal structure; and a method of testing a metal structure for corrosion.

The present invention facilitates the inspection of a metal surface (in particular of prestressing systems) for corrosion by means of rendering visible or detectable the presence of corrosion, also on built-in prestressing steel or a covered metal surface, provided that the metal surface is furnished with the corrosion protection agent according to the present invention. When applied to the metal surface, the corrosion protection agent protects the metal surface against corrosion-promoting moisture to a certain degree. However, if the metal surface is in fact exposed to moisture (i. e. water) and corrodes (e. g. because the moisture barrier function of the corrosion protection agent has been impaired over time), metal ions usually go into aqueous solution; in this case, the pH value of the solution is also liable to change. If said aqueous solution now comes into contact with the corrosion protection agent according to the present invention, a modification of the absorption spectrum of the indicator within the range of ultraviolet, visible or infrared light will occur (e. g. the color of the indicator will change) if said indicator, for example, forms a colored complex with a metal cation or changes its color depending on the pH value. If this effect is sufficiently pronounced, it is detectable or even visible to the naked eye because the corrosion protection agent according to the present invention is light-transmissive. According to the present invention, oxygen and water (which can lead to the formation of colored iron oxide, i. e. corrosion/rust) are certainly not to be considered as possible indicators in the corrosion protection agent, as this would be contradictory to the concept of corrosion protection per se.

In an aspect of the present invention described further below, a test method for corrosion (and a corresponding device) is disclosed which is based on the interaction of evanescent waves generated by a light beam in an optical wave guide and an indicator. The corrosion protection agent according to the present invention is excellently suitable for this method.

While means and metal coatings comprising a metal ion indicator are already known in the prior art, these relate to entirely different technical problems and do therefore neither disclose nor suggest the present invention:

Document WO 2013/185131 A1 relates to inorganic metal coatings, as for example employed in aircraft construction. These coatings are neither light-transmissive, like the corrosion protection agent according to the present invention, nor does the document provide any indication of a connection with prestressing systems or the like. Furthermore, the problem to be solved in document WO 2013/185131 A1 is entirely different from the problem underlying the present invention; the object of document WO 2013/185131 A1 consists in determining the degree of coverage of an inorganic metal coating applied on a metal structure (“coating coverage”).

Document DE 10 2004 050 150 A1 relates to a corrosion test agent which is employed in connection with a device for testing the protective effect of surface coatings against a corrosive attack by environmental influences or media. Similar to the above-mentioned document WO 2013/185131 A1, said document also relates to the inspection of metal coatings applied to metallic components. The preferred solvent comprised in the corrosion test agent is water, organic solvents are not mentioned. Moreover, said corrosion test agent is intended for a merely temporary application onto the component. In addition, it is obvious that said corrosion test agent is not suitable for the use as a corrosion protection agent: quite to the contrary, the corrosion test agent according to this document contains a conducting salt which actually promotes corrosion.

Document DE 10 2005 055 028 A1 relates to means and methods for testing corrosion protection coatings and is, from a technical point of view, very similar to document DE 10 2004 050 150 A1 as discussed in the previous paragraph. The agent according to this document even contains oxidizing chemicals as a substantial feature.

U.S. Pat. No. 5,646,400 relates to a device and a method for the detection and/or monitoring of corrosion by optical means in a structure such as an aircraft fuselage. However, the patent specification neither discloses a corrosion protection agent, nor a corrosion protection agent comprising an oil, a fat or a wax, nor a thixotropic corrosion protection agent.

Document US 2010/107741 A1 relates to a colorimetric corrosion test for the use in a braking system. In this test, a sample of the brake fluid present in the braking system is taken and contacted with a metal ion indicator. The brake fluid, however, is neither thixotropic nor is it employed for the purpose of corrosion protection.

GB Patent No. 2,425,835 relates to a method for detecting corrosion on a metal surface, wherein the metal surface is sprayed with a solution containing a binding agent and a metal chelating agent acting as a fluorescent indicator and the surface is subsequently exposed to UV radiation. This solution, however, is neither a corrosion protection agent, nor does it comprise an oil, a fat or a wax, and it is most certainly not thixotropic.

Document WO 2009/126802 A1 relates to a corrosion detection method as well as to a corresponding product. The method substantially comprises providing a coating containing a film-forming material and a complexing agent acting as a metal ion indicator, furnishing a substrate with said coating and irradiating the coating in order to detect any potential corrosion. However, said coating neither comprises an oil, a fat or a wax, nor is it thixotropic.

Document US 2003/068824 A1 relates to a corrosion-detecting composition and a corresponding method of use thereof. It is disclosed that the composition is an aqueous gel containing a corrosion indicator which is intended for coating the surface of a material. However, said composition neither acts as a corrosion protection agent, nor does it comprises an oil, a fat or a wax, and it is most certainly not thixotropic.

Non-bonded prestressing systems (e. g. prestressing steel) can be installed on the inside or the outside of a support structure (concrete section). The former are referred to as internal, and the latter as external prestressing systems. Corrosion protection materials in non-bonded prestressing systems, in particular for prestressing steel, usually are supposed to serve two main purposes, i. e. for improving the gliding properties of the metallic tendons in order to reduce frictional losses in the tensioning process as well as over the entire period of use, and for reducing and/or inhibiting corrosion of the metallic tendons.

The organic component of the corrosion protection agent according to the present invention is an oil, a fat or a wax (or a mixture thereof). The organic component usually serves as a moisture barrier (in other words: for the hydrophobization of the metal surface) and, in particular, as a lubricant. Therefore, the organic component of the corrosion protection agent according to the present invention usually has a poor solubility or even is insoluble in water. In particular, the corrosion protection agent according to the present invention is based on an oil, a fat or a wax, i. e. the oil, fat or wax represents the main constituent of the corrosion protection agent in relation to the total mass and can, for example, serve as a solvent or carrier.

According to a definition which is preferred within the scope of the present invention, a mixture of substances (or a substance) is referred to as an oil if it is present in a liquid state at a temperature of 25° C., has a higher viscosity than water and is not miscible with water (i. e. forms separate phases upon an attempt to be mixed with water). There are, inter alia, fatty oils (mixtures of fatty acid triglycerides from animals or plants), mineral oils and silicone oils. According to the present invention, a member of the two latter groups, in particular a member of the group of mineral oils, is preferred as an organic component.

According to a definition which is preferred within the scope of the present invention, a mixture of substances (or a substance) is referred to as a fat if it contains (or is) at least one fatty acid triglyceride, is present in a solid state at a temperature of 25° C., and is substantially insoluble in water. Among others, fats can be of animal or plant origin.

According to a definition which is preferred within the scope of the present invention, a mixture of substances (or a substance) is referred to as a wax if it (i) contains at least one substance having long, unsaturated alkyl chains (usually >C₁₅) and (ii) is kneadable and solid to brittle-rigid and at a temperature of 20° C. to 25° C., and melts into a low-viscosity liquid at a temperature of 40° C. to 45° C.

The person skilled in the art is well capable of selecting an organic component which is suitable for the corrosion protection agent, in particular from known oils (e. g. lubricating oils), fats (e. g. lubricating fats) and waxes, at a suitable concentration (and optionally with suitable additives) in order to ensure the light transmittance of the corrosion protection agent according to the present invention.

As the corrosion of metals leads to the formation of metal cations, an indicator for metal cations is particularly suitable in the sense of the present invention. In a preferred embodiment of the present invention, the modification of the absorption spectrum of the indicator is thus effected by means of coordinative binding of the indicator to a metal cation (i. e. the formation of a metal cation-indicator-complex). In a further preferred embodiment, the indicator of the corrosion protection agent according to the present invention can form a colored complex with a metal cation.

The corrosion protection agent according to the present invention is preferably employed on a steel surface. Corrosion of a steel surface leads to the formation of iron cations. According to the present invention, it is thus advantageous if the modification of the absorption spectrum of the indicator is effected by means of coordinative binding of the indicator to an iron cation (i. e. the formation of an iron cation-indicator-complex). In a further preferred embodiment, the indicator of the corrosion protection agent according to the present invention can form a colored complex with an iron cation.

Metal-ion indicators and iron-ion indicators, respectively, are well-known in the prior art. Preferably, the indicator of the corrosion protection agent according to the present invention is selected from the group of phthalocyanines, in particular from 29H,31H-tetrabenzo[b,g,l,q][5,10,15,20]tetraazaporphine and 1,10-phenanthroline, octyl gallate, propyl gallate, salicylic acid, 2,2′-bipyridine and 5-methyl-resorcine and mixtures thereof. Phthalocyanines, in particular 29H,31H-tetrabenzo[b,g,l,q][5,10,15,20]tetraazaporphine, are particularly preferred as indicators in the sense of the present invention.

Preferably, the indicator of the corrosion protection agent according to the present invention is a chemical substance which reacts to the presence of corrosion on the metal surface, in particular due to complex formation, by modifying its absorption spectrum within the range of ultraviolet, visible or infrared light, preferably by changing its color. Preferably, the indicator is a complexing agent.

The corrosion protection agent according to the present invention is preferably introduced by means of pumping or injection (in particular into the hollow space between the strand and the sheath of a sheathed strand, e. g. a monostrand). The corrosion protection agent according to the present invention is thus advantageously thixotropic within a temperature range of between −25° C. and 80° C., preferably between −10° C. and 50° C., and in particular between −5° C. and 30° C., thus facilitating the process of pumping or injecting at the usual ambient temperatures.

One technical solution for thixotropicizing the corrosion protection agent according to the present invention is as follows: In a further particularly preferred embodiment of the present invention, the corrosion protection agent comprises a thermoplastic elastomer as a thixotropicizing agent. Preferably, the thermoplastic elastomer is a light-transmissive, preferably linear, diblock copolymer on the basis of styrene and ethylene/polypropylene (S-E/P). Further light-transmissive thermoplastic elastomers are known to the person skilled in the art.

Within the scope of the present invention, it has further been found that oil is more suitable for the use as an organic component in a prestressing system than fat or wax. Thus, the organic component comprised in the corrosion protection agent according to the present invention is preferably an oil, preferably a silicone oil or a mineral oil, in particular a mineral oil.

In a further preferred embodiment of the corrosion protection agent according to the present invention, said organic component is a base oil selected from groups I to V as defined by the American Petroleum Institute (API), preferably from groups II to V, more preferably from groups II to III and in particular from group II. The group II base oil has the particular advantage that it is clearer (i. e. more light-transmissive) than a group I oil, while its use is more efficient than the use of a group III oil.

Advantageously, the corrosion protection agent according to the present invention further comprises a corrosion inhibitor and/or an antioxidant, which serves the purpose of further slowing down or even inhibiting the corrosion of the metal surface in addition to the fact that the corrosion protection agent according to the present invention preferably constitutes a moisture barrier, which in turn is due to the presence of an organic component that is, in particular, selected from an oil, a fat or a wax. The corrosion protection agent is, for example, selected from nonylphenoxyacetic acid (such as IRGACOR® NPA, BASF SE), N-acyl sarcosine (such as SARKOSYL® 0, BASF SE), amine phosphates (such as IRGALUBE® 349, BASF SE) and mixtures thereof. The antioxidant is, for example, selected from 2,2′-thiodiethylene-bis(3,5-di-tert-butyl hydroxyhydrocinnamate) (such as BRD-CHEM® 395, Brad-Chem Ltd.), alkyl diphenylamine (such as BRD-CHEM® 332, Brad-Chem Ltd.), pentaerythritol-tetrakis(3,5-di-tert-butyl-4-hydroxyhydrocinnamate) (such as BRD-CHEM® 391, Brad-Chem Ltd.), octadecyl-3-(3,5-di-tert-butyl-4-hydroxyphenyl)propionate (such as BRD-CHEM® 397, Brad-Chem Ltd.) and mixtures thereof. Further corrosion inhibitors and antioxidants are known in the prior art. The person skilled in the art is well capable of selecting suitable corrosion inhibitors and antioxidants at a suitable concentration in order to substantially maintain the light transmittance of the corrosion protection agent according to the present invention.

In a further aspect of the present invention, a method is provided for furnishing a metal structure, which is surrounded by a sheath, with a corrosion protection agent. The method is characterized in that the corrosion protection agent according to the present invention is pumped in between the metal structure and the sheath. To this end, it is particularly advantageous if the corrosion protection agent according to the present invention is thixotropic in order to be able to re-solidify after the pump-in procedure. The metal structure preferably is a prestressing steel (in particular a strand) and can additionally be coated with a layer (such as a zinc layer). The sheath is preferably made of a synthetic material, more preferably of a thermoplastic synthetic material such as polyethylene, in particular high-density polyethylene (“HDPE”).

In a further aspect of the present invention, a metal structure is provided which is characterized in that it is furnished with the corrosion protection agent according to the present invention. The metal structure preferably is a prestressing steel (in particular a strand) and can additionally be coated with a layer (such as a zinc layer). The metal structure can also be a wire rope, in particular a steel wire rope. In particular, the metal structure is surrounded by a sheath and the corrosion protection agent is present between the sheath and the metal structure. The sheath is preferably made of a synthetic material, more preferably of a thermoplastic synthetic material such as polyethylene, in particular high-density polyethylene (“HDPE”).

The detection of the indicator which has, for example, taken on a specific color due to the presence of corrosion, can be performed, for example, by means of inspection with the naked eye. To this end, the sheath of the metal structure is advantageously provided in a light-transmissive form.

As the metal structure which is furnished with a corrosion protection agent is possibly no longer accessible to a naked-eye inspection after having been installed because it represents, for example, a prestressing steel arranged inside a concrete structure, photometric measuring units can further be provided in the corrosion protection agent, e. g. at regular intervals along the entire length. However, particularly suitable for the detection of the indicator having undergone a modification of its absorption spectrum (i. e. having taken on a specific color, for example) due to the presence of corrosion is a device which will be disclosed in the following.

In a further aspect of the present invention, a device is provided which is arranged on a metal structure. The device comprises a light-transmissive element, which preferably is a light-transmissive fiber, and a corrosion protection agent, which has been applied onto a surface of the metal structure. The device is characterized in that said corrosion protection agent is implemented as the corrosion protection agent according to the present invention, wherein the light-transmissive element is provided in the form of an optical wave guide having a boundary surface between the element and the corrosion protection agent. The metal structure is preferably a prestressing steel (in particular a strand), and can additionally be coated with a layer (such as a zinc layer). The metal structure can also be a wire rope, in particular a steel wire rope. Preferably, the metal structure is part of a building, in particular a concrete construction.

The device according to the present invention enables the detection of the indicator, which has reacted to the presence of corrosion on the metal surface by modifying its absorption spectrum (for example with the formation of a colored indicator or ion-indicator-complex) and is present in the corrosion protection agent, by means of an interaction of the indicator and an evanescent field, wherein the field is generated by a light beam in the light-transmissive element which is provided in the form of an optical wave guide. The device according to the present invention is thus particularly suitable for facilitating a corrosion inspection of the metal structure because it enables an in situ inspection of the metal structure, that is, for example, without removing the metal structure (if it is, for example, a prestressing steel) from the surrounding concrete construction. One possible way of implementing the inspection is illustrated in the following:

The corrosion protection agent has a refractive index n₂. A boundary surface is present between the corrosion protection agent of the device and the light-transmissive element of the device, for example, in the form of a light-transmissive fiber provided along the longitudinal axis of the metal structure through the corrosion protection agent. With respect to its refractive index n₁ (for example by providing a specific type of glass fiber) and its diameter, the light-transmissive element (such as a glass fiber) is implemented in such a manner that a light beam, which is coupled into the light-transmissive element, is totally reflected at the boundary surface—i. e. the light-transmissive element will act as an optical wave guide. Evanescence occurs when the light beam is totally reflected at the boundary surface within the the optical wave guide. In this manner, the light beam can also interact with, and optionally be absorbed by, those molecules of the corrosion protection agent that are located beyond the boundary surface. In case of a modification of the absorption spectrum (such as a change in color) at the wavelength λ_{I}, which occurs due to the presence of corrosion, of the indicator present in the corrosion protection agent in the vicinity of the boundary surface (on the molecular level, there are also, for example, Fe²⁺-indicator-complexes present near the boundary surface, which absorb light of the wavelength λ_{I}, in other words: which are, for example, colored), the intensity of the light beam at the wavelength λ_{I} will correspondingly be reduced upon total reflection at the boundary surface.

For instance, it is possible to record a reference spectrum of a coupled-in light beam when the first inspection is conducted (for example, immediately upon completion of a building at whose metal structure the device is arranged). The inspection will be repeated at regular intervals, wherein, for example, decreases in intensity of the wavelength λ_{I} in the recorded spectrum of the light beam as compared to the reference spectrum indicate the presence of corrosion in the metal structure.

In the prior art, optical wave guides are known in connection with an inspection for corrosion, but not in connection with an indicator which reacts to the presence of corrosion on the metal surface by modifying its absorption spectrum within the range of ultraviolet, visible or infrared light. The prior art cited in the following thus neither anticipates nor suggests the present invention:

Document WO 2004/031738 A1 relates to an optical wave guide which is employed as a corrosion sensor. The optical wave guide can, for example, be arranged axially along the surface of the structure to be monitored or it can be wound around the surface of the metal structure to be monitored. However, the optical wave guide is merely intended for measuring the temperature or the presence of a fluid. The measurement of a corrosion-related modification of the absorption of an indicator is not disclosed in this document.

Die CN 203259173 U relates to a corrosion monitoring sensor which is based on an optical wave guide and is intended for the use in bridge constructions. According to this document, the monitoring is not based on the detection of a modification of the absorption of an indicator.

Furthermore, documents WO 98/40728 A1 and DE 10 2012 207 179 A1 disclose further devices and methods for corrosion monitoring in buildings which are not based on optical wave guides: the object of the former document is based on an impedance measurement on a surface of reinforced concrete, while the latter document relates to a metal tube surrounded by an at least two-layered corrosion protection sheathing having an upper and a lower layer, characterized in that the lower layer is equipped in such a manner that an optical or electrical signal can be detected in case of damage to the one or more layers arranged above said layer.

Total reflection occurs an the boundary surface of a medium having a higher optical density with a refractive index n₁ and a medium having a lower optical density with a refractive index n₂ if the incident angle of the light in the medium having a higher optical density an the boundary surface exceeds a specific value, which is also referred to as the critical angle of total reflection. The concept of a total, i. e. complete, reflection of a wave is an idealization because, in practice, a certain proportion of “completely or totally” reflected radiation will always be lost due to absorption. In the sense of the present invention, the term “total reflection” is thus to be understood according to a practical interpretation, as is obvious to the person skilled in the art. The critical angle Θ_{c} of total reflection (which is usually determined based on the normal, i. e. the perpendicular, of the boundary surface) can be calculated from the refractive indices of the media, n₂ and n₁, as follows:

$${θ}_{c} = arcsin ( \frac{{n}_{2}}{{n}_{1}} )$$

From this it also follows that the diameter of the light-transmissive element (e. g. the glass fiber) must not exceed a specific maximum diameter in order to meet the minimum value for the critical angle Θ_{c} in any given reflection event when a certain light beam spreads in the element.

Typically, a light-transmissive medium will act as an optical wave guide if it is surrounded by a material having a lower optical density and if the light spreading in the medium cannot leave the medium due to total reflection at the boundary surface and is instead reflected at an emergent angle which equals the incident angle, which results in a repetitively occurring total reflection at the boundary surface while the light is spreading in the medium.

The physical phenomenon of evanescence is employed in a plurality of measuring methods. One example for this is the method of ATR (attenuated total reflection) infrared spectroscopy for examining the surfaces of opaque materials such as paint layers.

One crucial parameter in this context is the depth of penetration dₚ of the evanescent wave which is defined as the distance from the boundary surface at which the amplitude of the electric field corresponds to a proportion of merely 1/e (about %) of the amplitude at the boundary surface. If light of the wavelength λ transitions at an incident angle Θ from a medium having a higher optical density (such as the light-transmissive element with the refractive index n₁) into a medium having a lower optical density (such as the corrosion protection agent with the refractive index n₂), the following equation applies:

$${d}_{P} = \frac{λ}{2 π \sqrt{{n}_{1}^{2} {sin}^{2} ( Θ ) - {n}_{2}^{2}}}$$

For a typical angle Θ within the range of around 45° and a typical refractive index ratio, it can be estimated that the depth of penetration will be about ⅕ to ¼ of the wavelength of the incident light, wherein the depth of penetration decreases with the increase of the refractive index ratio n₁/n₂.

As the depth of penetration at wavelengths of 380 nm to 780 nm (i. e. in the visible range of light) is typically in the submicron range, it is advantageous to enlarge the boundary surface in order to increase measuring sensitivity. In a preferred embodiment of the device, the light-transmissive element is thus guided in the corrosion protection agent along the longitudinal axis of the metal structure, wherein the length of the light-transmissive element comprised in the corrosion protection agent is preferably at least 50%, preferably at least 60%, more preferably at least 70%, even more preferably at least 80% and in particular at least 90% of the length of the metal structure. In a particularly preferred embodiment, the light-transmissive element comprised in the corrosion protection agent is wound around the metal structure.

Furthermore, the light-transmissive element may optionally consist of a plurality of materials each having a different optical density. For instance, portions of the light-transmissive element may consist of a glass fiber core which is surrounded by a glass sheath having a lower optical density.

In a further aspect of the present invention, a method is provided for testing a metal structure, preferably prestressing steel, in particular present in the form of a strand, for corrosion. The method is characterized in that the metal structure is equipped with the device according to the present invention and the method comprises:
coupling a light beam into the light-transmissive element of the device,
reflecting at least a portion of the light beam at said boundary surface located between the element and the corrosion protection agent of the device,
coupling the light beam out of the element, and
detecting the coupled-out light beam.

At any rate, the light beam to be coupled in must at least have a wavelength that is sufficient to induce a modification of the absorption spectrum of the indicator in case of the presence of corrosion. The detection must also be performed at this minimum wavelength. Advantageously, said wavelength is a wavelength at which the corrosion protection agent exhibits only a negligible degree of absorption in the absence of corrosion.

The light beam to be coupled in can be broadband (such as white light) or monochromatic, e. g. having a wavelength corresponding to the absorption maximum of the indicator, if the latter has already taken on a specific color due to the presence of corrosion. The light beam to be coupled in can be in a spectrum range that is visible to humans (380 nm to 780 nm wavelength) and/or in the ultraviolet (between 10 nm and 380 nm, preferably between 100 and 380 nm, more preferably between 170 and 380 nm, even more preferably between 190 and 380 nm and in particular between 250 and 380 nm wavelength) or in the near-infrared range (between 780 nm and 10000 nm, preferably between 780 and 3500 nm, more preferably between 780 and 2600 nm, even more preferably between 780 and 1400 nm and in particular between 780 and 1100 nm wavelength).

Suitable light sources for generating the light beam to be coupled in (such as a light bulb with tungsten wire, a xenon flash bulb, a halogen bulb or a laser beam) and suitable detectors for detecting the coupled-out light beam (such as a photoelectric cell or a photoelectric diode) are known to the person skilled in the art. Moreover, the person skilled in the art is readily capable of optionally providing further optical elements, such as color filters, monochromators, tilted mirrors or lenses arranged before the point of coupling in or after the point of coupling out.

### Further Definitions

According to the present invention, “ultraviolet light” is to be considered as electromagnetic radiation in a wavelength range between 10 nm and 380 nm, preferably between 100 nm and 380 nm, more preferably between 170 nm and 380 nm, even more preferably between 190 and 380 nm and in particular between 250 nm and 380 nm.

According to the present invention, “visible light” is to be considered as electromagnetic radiation in a wavelength range between 380 nm and 780 nm.

According to the present invention, “infrared light” is to be considered as electromagnetic radiation in the near-infrared range, i. e. in a wavelength range between 780 nm and 10000 nm, preferably between 780 nm and 3500 nm, more preferably between 780 and 2600 nm, even more preferably between 780 nm and 1400 nm and in particular between 780 nm and 1100 nm.

A “change in color” is primarily to be considered as a change from one color to another. However, it is also possible that the indicator is colorless in the absence of corrosion and only takes on a color in the presence of corrosion (e. g. by means of coordinative binding of an iron cation); according to the present invention, this phenomenon is also referred to as a change in color. A reverse order of events is also conceivable, i. e. the indicator initially has a color and becomes colorless in the presence of corrosion; according to the present invention, this phenomenon is also referred to as a change in color.

The property of light transmittance of the corrosion protection agent according to the present invention is to be considered depending on the indicator selected: Light transmittance must be provided, at least for light of a selected wavelength, at which wavelength the absorption spectrum of the indicator may change depending on the presence of corrosion.

According to a definition which is preferred within the scope of the present invention, the term “light-transmissive” is to be interpreted as follows: The extinction for a specific wavelength is the decadic logarithm of the ratio of the intensity of the radiation entering the medium, I₀, and the intensity of the radiation leaving the medium (i. e. the detected radiation), I, for a specific wavelength. The extinction of distilled water for a layer thickness d at 25° C. and normal pressure be defined as 0 (i. e. by definition: I₀=I). Given an unaltered intensity of the incident radiation I₀ (i. e. with the use of the same light source) at identical ambient conditions and an identical layer thickness d, the relative extinction of the corrosion protection agent is now determined by measuring the intensity I_{K}; the relative extinction then results from the decadic logarithm of the ratio of I/I_{K}. A corrosion protection agent is considered as light-transmissive if said relative extinction is below 4, preferably below 1, more preferably below 0.5, even more preferably below 0.25 and in particular below 0.125 or even below 0.0625 at a selected electromagnetic wavelength (or a selected wavelength range with, e. g., a breadth of 10 or 100 nm) within a range of 10 nm to 10000 nm, preferably within a range of 170 nm to 3500 nm, more preferably within a range of 190 nm to 2600 nm, even more preferably within a range of 320 nm to 1400 nm and in particular within a range of 380 nm to 780 nm. (The relative extinction can also be negative, i. e. the corrosion protection agent is more light-transmissive than water at the given wavelength). When determining the extinction, a typical (and thus preferable) layer thickness d is 1 cm, which corresponds to a conventional laboratory cuvette. The determination of the relative extinction can, for example, be performed in a wavelength range of 190 nm to 1100 nm in a conventional laboratory spectrophotometer with a cuvette insert, wherein the water sample mentioned above serves as a “blank”; in case of corrosion protection agents having a higher absorption, the person skilled in the art is readily capable of performing corresponding serial dilutions in order to be able to work within the photometric linearity range of the spectrophotometer.

In particular, “light-transmissive” means “transparent” in the sense of the present invention, i. e. light that is visible to humans, at least within a selected range of color that is visible to humans, in particular in each range of color that is visible to humans, is substantially not absorbed (e. g. in the case of water or a silicone oil or in the case of oils that are referred to as “water-clear”).

The present invention is further illustrated by means of the following Examples, of course without being limited thereto.

### EXAMPLE 1 PREPARATION OF THE CORROSION PROTECTION AGENT

Formulation:

| | | Manufac- | | % by |
|---|---|---|---|---|
| Function | Product | turer | Ingredient(s) | weight |
| Organic | PURITY | Petro- | | 78.4 |
| component | 1810 | Canada | | |
| | base oil | | | |
| Thermo- | G1701 E | Kraton | Linear diblock | 18.0 |
| plastic | | Polymers | co-polymer on | |
| elastomer | | | the basis of | |
| | | | styrene and | |
| | | | ethylene/ | |
| | | | propylene | |
| | | | (S-E/P) | |
| Corrosion | IRGACOR ® | BASF | Nonyl- | 1.5 |
| protection | NPA | SE | phenoxyacetic | |
| agent | | | acid | |
| Anti- | BRAD- | Brad- | 2,2′-Thiodi- | 0.6 |
| oxidant | CHEM ® | Chem | ethylene-bis(3,5- | |
| | 395 | Ltd. | di-tert-butyl- | |
| | | | hydroxyhydro- | |
| | | | cinnamate) | |
| Indicator | Saturated | | 29H,31H- | 1.5 |
| | solution in | | Tetrabenzo | |
| | PURITY 1810 | | [b,g,l,q][5,10,15,20] | |
| | base oil | | tetraazaporphine | |
| | | | | 100 |

Beforehand, a saturated indicator solution in a small portion of the base oil was prepared. Also beforehand, the thermoplastic elastomer was suspended in another small portion of the base oil. The corrosion protection agent was prepared as follows:

The remaining, major portion of the base oil was provided and mixed with the corrosion inhibitor, the antioxidant and the indicator solution according to the above formulation.

Subsequently, the suspended elastomer according to the above formulation (calculated based on the weight of the elastomer before its suspension) was added. The mixing procedure was performed by means of a slowly running stirring unit with wall scrapers. The process was accelerated by heating the base oil to 40° C.

The addition of the elastomer increases the viscosity of the mixture. The corrosion protection agent was thus discharged by means of forced conveying.

### EXAMPLE 2—CORROSION INDICATOR TEST

In order to test the corrosion protection agent according to Example 1 with respect to its ability of indicating the presence of corrosion, a slightly wet steel sponge with corroded patches was placed in a transparent glass container. The glass container was subsequently filled with the corrosion protection agent and incubated at room temperature. Within two days, the progressing corrosion of the metal sponge caused an intense red coloring of the corrosion protection agent, which extended from the regions of the corrosion protection agent in the vicinity of the corroded sites of the steel sponge. Over time, the coloring of these regions spread further through the corrosion protection agent.

### EXAMPLE 3—APPLICATIONS

A) For the preparation of a monostrand, the corrosion protection agent prepared according to Example 1 was applied under pressure onto a prestressing steel strand consisting of seven cold-drawn wires (grade St 1570/1770) in an amount of 60 grams per meter of strand. The strand was sheathed with polyethylene.

B) In order to furnish a sheathed strand with the corrosion protection agent, the corrosion protection agent prepared according to Example 1 was pumped into the hollow space between the sheath and the strand by means of an air-driven gear pump with pressure follower plate (“UNIPUMP 5:1 air-driven gear pump”, WERBA-CHEM GMBH) at an excess pressure of 0.5 bar.

C) In order to furnish a strand anchor head with the corrosion protection agent, the corrosion protection agent prepared according to Example 1 was pumped into the strand anchor head by means of an air-driven gear pump with pressure follower plate (“UNIPUMP 5:1 air-driven gear pump”, WERBA-CHEM GMBH) at an excess pressure of 0.5 bar.

1. A corrosion protection agent for a metal surface, wherein the corrosion protection agent comprises an organic component, wherein the organic component is an oil, a fat or a wax, and wherein the corrosion protection agent is thixotropic,
wherein the corrosion protection agent is light-transmissive and further comprises an indicator which reacts to the presence of corrosion on the metal surface by modifying its absorption spectrum within the range of ultraviolet, visible or infrared light, in particular by changing its color.

2. The corrosion protection agent of claim 1, wherein said modification of the absorption spectrum is effected by coordinative binding of the indicator to a metal cation.

3. The corrosion protection agent of claim 2, wherein the metal cation is an iron cation.

4. The corrosion protection agent of claim 1, wherein the indicator is selected from the group of phthalocyanines, in particular from 29H,31H-tetrabenzo[b,g,l,q][5,10,15,20]tetraazaporphine and 1,10-phenanthroline, octyl gallate, propyl gallate, salicylic acid, 2,2′-bipyridine and 5-methyl-resorcine and mixtures thereof.

5. The corrosion protection agent of claim 1, wherein the corrosion protection agent is thixotropic within a temperature range between −25° C. and 80° C.

6. The corrosion protection agent of claim 1, further comprising a thermoplastic elastomer as a thixotropicizing agent.

7. The corrosion protection agent of claim 1, wherein the organic component is a base oil selected from groups I to V, preferably from groups II to V, more preferably from groups II to III and in particular from group II as defined by the American Petroleum Institute (API).

8. The corrosion protection agent of claim 1, wherein the corrosion protection agent further comprises a corrosion inhibitor and/or an antioxidant.

9. A method for furnishing a metal structure, which is surrounded by a sheath, with a corrosion protection agent,
wherein the corrosion protection agent of claim 1 is pumped into the hollow space between the metal structure and the sheath.

10. A metal structure, wherein the metal structure is furnished with the corrosion protection agent of claim 1.

11. The metal structure of claim 10, wherein the metal structure is surrounded by a sheath and the corrosion protection agent is located between the sheath and the metal structure.

12. The metal structure of claim 10, wherein the metal structure is a prestressing steel.

13. A device arranged on a metal structure,
comprising a light-transmissive element and a corrosion protection agent, wherein the corrosion protection agent is applied onto a surface of the metal structure,
wherein the corrosion protection agent is implemented of claim 1, and
wherein the element is provided in the form of an optical wave guide having a boundary surface between the element and the corrosion protection agent.

14. A method for testing a metal structure for corrosion,
wherein the metal structure is equipped with a device of claim 13, the method comprising
coupling a light beam into the light-transmissive element of the device,
reflecting at least a portion of the light beam at said boundary surface located between the element and the corrosion protection agent of the device,
coupling the light beam out of the element, and
detecting the coupled-out light beam.

15. The metal structure of claim 12, wherein the prestressing steel is a strand.

16. The device of claim 13, wherein the light-transmissive element is a light-transmissive fiber.

17. The method of claim 14, wherein the metal structure is a prestressing steel.

18. The method of claim 17, wherein the prestressing steel is a strand.

19. The corrosion protection agent of claim 5, wherein the corrosion protection agent is thixotropic within a temperature range between −10° C. and 50° C. and in particular between −5° C. and 30° C.

20. The corrosion protection agent of claim 19, wherein the corrosion protection agent is thixotropic within a temperature range between −5° C. and 30° C.
